(19) United States
(12) Patent Application Publication
(10) Pub. No.: US 2008/0104323 A1
(43) Pub. Date: May 1, 2008

(54) METHOD FOR IDENTIFYING, TRACKING, AND STORING HOT CACHE LINES IN AN SMP ENVIRONMENT

(76) Inventors: Daniel J. Colglazier, Cary, NC (US); Marcus L. Kornegay, Durham, NC (US); Ngan N. Pham, Raleigh, NC (US); Jorge R. Rodriguez, Cary, NC (US)

Correspondence Address: HOFFMAN WARNICK & DALESSANDRO LLC, 75 STATE STREET, 14TH FLOOR, ALBANY, NY, 12207, US

(21) Appl. No.: 11/553,268

(22) Filed: Oct. 26, 2006

(51) Int. Cl. G06F 12/00

(52) U.S. Cl. 711/122

(57) ABSTRACT

The invention is directed to the identifying, tracking, and storing of hot cache lines in an SMP environment. A method in accordance with an embodiment of the present invention includes: accessing, by a first processor, a cache line from main memory; modifying and storing the cache line in the L2 cache of the first processor; requesting, by a second processor, the cache line; identifying, by the first processor, that the cache line stored in the L2 cache of the first processor has previously been modified; marking, by the first processor, the cache line as a hot cache line; forwarding the hot cache line to the second processor; modifying, by the second processor, the hot cache line; and storing the hot cache line in the hot cache of the second processor.

### BACKGROUND OF THE INVENTION

1. Field of the Invention

The present invention generally relates to symmetric multiprocessor (SMP) environments. More specifically, the present invention is directed to a method for identifying, tracking, and storing hot cache lines in an SMP environment.

2. Related Art

Many applications that run in SMP environments have pieces of data (cache lines) that are often read and modified by multiple caching agents. These cache lines are known as “hot cache lines” and are typically important instructions or data that multiple caching agents must touch in order for multi-threaded applications to run effectively. Database and other workloads/application environments have high frequencies of hot cache line accesses. The fact that multiple caching agents must access these cache lines means that there is certain overhead (latencies) due to the coherency protocol and cache lookup times that are incurred when these cache lines are passed from one processor to the next. Processor cache sizes are steadily increasing and thus the access time to reference cache lines stored in the cache are increasing proportionally, which will further increase latency and reduce system performance.

Accordingly, there is a need for a method of tagging, tracking, and storing hot cache lines to reduce the overhead of hot cache line accesses.

### SUMMARY OF THE INVENTION

The present invention is directed to a method for identifying, tracking, and storing hot cache lines in an SMP environment. In particular, in one embodiment, a data tagging scheme and a small, high speed cache (“hot cache”) are used to identify, track and store hot cache lines. The small size of the hot cache results in lower access times, reducing latency to the hot cache lines, thus increasing system performance. The tagging scheme can be a bit or a series of bits that are enabled when a cache line is read and modified by more than one caching agent. The hot cache is preferably much smaller than the last level (L2) processor cache. The hot cache provides quick access when a caching agent requests to read and modify a hot cache line. The hot cache can also use the L2 processor cache as a victim cache.

A first aspect of the present invention is directed to a method for identifying, tracking, and storing hot cache lines in a multi-processor environment, each processor including a last level (L2) cache and a separate hot cache, comprising: accessing, by a first processor, a cache line from main memory; modifying and storing the cache line in the L2 cache of the first processor; requesting, by a second processor, the cache line; identifying, by the first processor, that the cache line stored in the L2 cache of the first processor has previously been modified; marking, by the first processor, the cache line as a hot cache line; forwarding the hot cache line to the second processor; modifying, by the second processor, the hot cache line; and storing the hot cache line in the hot cache of the second processor.

A second aspect of the present invention is directed to a multiprocessor system, comprising: a plurality of processors, each processor including a last level (L2) cache and a hot cache separate from the L2 cache for storing hot cache lines, wherein a size of the hot cache of a processor is much smaller than a size of the L2 cache of the processor, and wherein an access latency of the hot cache of a processor is much smaller than an access latency of the L2 cache of the processor.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts an illustrative SMP environment employing a method for identifying, tracking, and storing hot cache lines in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As described above, the present invention is directed to a method for identifying, tracking, and storing hot cache lines in an SMP environment. In particular, in one embodiment, a data tagging scheme and a small, high speed cache (“hot cache”) are used to identify, track and store hot cache lines. The small size of the hot cache results in lower access times, reducing latency to the hot cache lines, thus increasing system performance. The tagging scheme can be a bit or a series of bits that are enabled when a cache line is read and modified by more than one caching agent. The hot cache is preferably much smaller than the last level (L2) processor cache. The hot cache provides quick access when a caching agent requests to read and modify a hot cache line. The hot cache can also use the L2 processor cache as a victim cache.

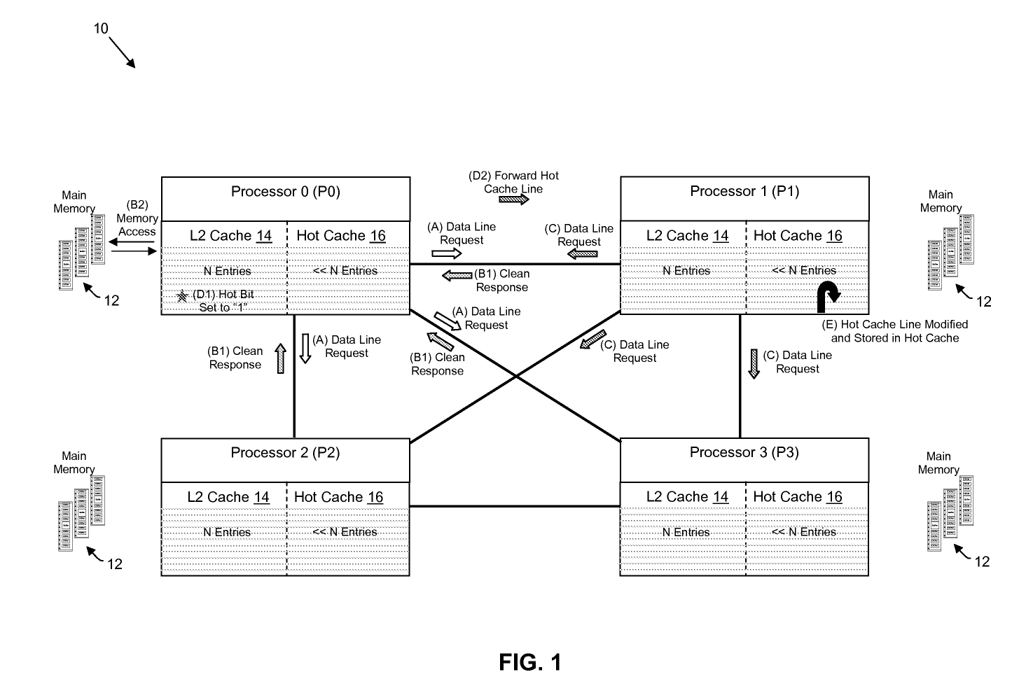

An illustrative SMP environment 10 employing a method for identifying, tracking, and storing hot cache lines in accordance with an embodiment of the present invention is depicted in FIG. 1. The SMP environment 10 includes a plurality of interconnected processors P0, P1, P2, P3, which share a main memory 12. Each processor P0, P1, P2, P3 includes an L2 cache 14 and a separate hot cache 16. Each L2 cache 14 includes “N” entries, while each hot cache 16 includes “<<N” entries (i.e., the hot cache 16 is much smaller than the L2 cache 14). As an example, each L2 cache 14 could be 8 MB in size, while each hot cache 16 could be 64 KB, 128 KB, or 256 KB in size. Other sizes of the L2 cache 14 and hot cache 16 are also possible.

The following scenario illustrates the identifying, tracking, and storing of hot cache lines in accordance with an embodiment of the present invention.

(A) P0 sends out a snoop request for a cache line (data line request) with read with intent to modify (RWITM).

(B) Snoop responses come back clean (B1) and the cache line is accessed (B2) from main memory 12 and modified by P0. The cache line is then stored by P0 in its L2 cache.

(C) P1 sends out a snoop request (data line request) to RWITM the same cache line that was recently modified by P0.

(D) P0 receives the snoop request sent out by P1 and identifies the cache line as one that was recently modified by P0. P0 marks (D1) a “hot bit” (e.g., a hot bit of the cache line is set to “1”) and forwards (D2) the hot cache line to P1.

(E) P1 modifies the hot cache line and then stores the hot cache line in its hot cache so that the next requester of the hot cache line will have fast access to the hot cache line.

The above process continues as necessary. For instance, when the hot cache line is accessed by another processor P, P1 will again mark a “hot bit” and forward the hot cache line to the requesting processor P. P1's entry for the hot cache line in its hot cache will then be invalidated. In this way, a hot cache line is identified in real time, and then allocated to a small, dedicated hot cache, thereby decreasing access latency and improving system performance.

At least some aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture, on one or more data storage portions of a computer system, such as memory and/or a storage system, and/or as a data signal traveling over a network (e.g., during a wired/wireless electronic distribution of the computer program code).

The foregoing description of the embodiments of this invention has been presented for purposes of illustration and description. It is not intended to be exhaustive or to limit the invention to the precise form disclosed, and many modifications and variations are possible.

What is claimed is:

1. A method for identifying, tracking, and storing hot cache lines in a multi-processor environment, each processor including a last level (L2) cache and a separate hot cache, comprising:
accessing, by a first processor, a cache line from main memory;
modifying and storing the cache line in the L2 cache of the first processor;
requesting, by a second processor, the cache line;
identifying, by the first processor, that the cache line stored in the L2 cache of the first processor has previously been modified;
marking, by the first processor, the cache line as a hot cache line;
forwarding the hot cache line to the second processor;
modifying, by the second processor, the hot cache line; and
storing the hot cache line in the hot cache of the second processor.

2. The method of claim 1, wherein the multi-processor environment comprises a symmetric multiprocessor (SMP) environment.

3. The method of claim 1, wherein a size of the hot cache of a processor is much smaller than a size of the L2 cache of the processor.

4. The method of claim 1, wherein an access latency of the hot cache of a processor is much smaller than an access latency of the L2 cache of the processor.

5. The method of claim 1, wherein the marking further comprises:
marking at least one hot bit in the cache line to identify the cache line as a hot cache line.

6. The method of claim 1, further comprising:
requesting, by another processor, the hot cache line; and
accessing the hot cache line from the hot cache of the second processor.

7. The method of claim 6, further comprising, after the accessing of the hot cache line:
invalidating an entry for the hot cache line in the hot cache of the second processor.

8. A multiprocessor system, comprising:
a plurality of processors, each processor including a last level (L2) cache and a hot cache separate from the L2 cache for storing hot cache lines, wherein a size of the hot cache of a processor is much smaller than a size of the L2 cache of the processor, and wherein an access latency of the hot cache of a processor is much smaller than an access latency of the L2 cache of the processor.

9. The system of claim 7, wherein the plurality of processors comprise a symmetric multiprocessor (SMP) environment.
